(19) United States
(12) Patent Application Publication
(10) Pub. No.: US 2024/0426291 A1
(43) Pub. Date: Dec. 26, 2024

(54) METHOD FOR MONITORING A HYDRAULIC SYSTEM

(71) Applicant: KRAUSSMAFFEI TECHNOLOGIES GMBH, Parsdorf (DE)

(72) Inventors: STEFAN MOSER, HALLBERGMOOS (DE); SINA GREGER-GÜRBÜZ, MÜNCHEN (DE); SEBASTIAN FRUTH, MÜNCHEN (DE)

(21) Appl. No.: 18/705,033

(22) PCT Filed: Oct. 26, 2022
(86) PCT No.: PCT/EP2022/079936

§ 371 Date: Apr. 26, 2024

(30) Foreign Application Priority Data
Nov. 3, 2021 (DE) 10 2021 128 543.7

(51) Int. Cl. F04B 49/08; F04B 49/10

(52) U.S. Cl. CPC F04B 49/08; F04B 49/10; F04B 2201/0803; F15B 2211/20546

(57) ABSTRACT

The application relates to a method for monitoring a hydraulic system including several hydraulic components, the hydraulic system comprising at least one pump and subsystems which can be shut off from one another and each have a hydraulic motor and/or a hydraulic cylinder as consumers. According to the application, leakage in the pump and in the subsystems is determined and, on the basis thereof, leakage in the consumers is subsequently determined. These values can be used to determine the efficiencies of the pump and the consumers.

The invention relates to a method for monitoring a hydraulic system. A preferred field of application are hydraulically driven injection moulding machines. However, the invention can basically be used in any hydraulic system.

The document DE 10 2019 117 820 A1 discloses a method for monitoring the status of a hydraulic pump of a hydraulic system of a moulding machine, in particular an injection moulding machine. The hydraulic pump is connected to a pressure line and is operated for providing a pressure in the pressure line with a displacement volume or a rotational speed. Provision is made that the displacement volume or the rotational speed of the hydraulic pump is suddenly changed. Through an analysis of a temporal reaction of the pressure in the hydraulic pump and/or in the pressure line, a status of the hydraulic pump is determined.

Proceeding herefrom, the invention is based on the problem of indicating a method for monitoring a hydraulic system consisting of several hydraulic components in which, without additional sensor technology or respectively with sensor technology which is present in any case in the hydraulic system, a monitoring of the status of all components, in particular of all pumps and consumers, can take place.

The solution to this problem is effected with the features of claim 1. Advantageous configurations and further developments are to be found in the dependent claims 2 to 11.

According to a core idea, the present invention proceeds from the following consideration. A hydraulic system consists of several hydraulic components and generally comprises a tank as a source of a hydraulic fluid, at least one hydraulic pump able to be driven by a motor, and one or more hydraulic consumers which are flowed through by the hydraulic fluid which is conveyed by the hydraulic pump. Valves are usually also present as further hydraulic components. The above-mentioned hydraulic components are connected together by means of lines to form a hydraulic system. For a monitoring of the status of such a hydraulic system, it is necessary to determine the status of each individual hydraulic component, but at least of the hydraulic pump. In a first step, the at least one hydraulic pump is measured within a hydraulic system, as its leakage affects all subsequent hydraulic components. Accordingly, the method according to the invention provides the following step (a): determining the leakage of the at least one hydraulic pump as a function of the pressure over predeterminable values of the pressure.

In a next step (b), subsystems which can be shut off from one another are considered. Such a subsystem is formed by the at least one hydraulic pump from step (a) and by a hydraulic consumer. The consumer carry a can out translatory or a rotatory movement and can thus move in a translatory or rotatory manner an actuator, which is in operative connection with this consumer. For the generating of a translatory movement, various embodiments, known per se, of a hydraulic cylinder can come into consideration. For the generating of a rotatory movement, various embodiments, known per se, of a hydraulic motor can come into consideration. Depending on how complete the monitoring is to be configured, individual subsystems which can be shut off from one another or all subsystems which can be shut off from one another, can be considered and examined.

In a next step (c) the determining of the leakage of the consumers of the subsystems operated according to step (b) takes place. For this, the difference value is formed between the leakage of the subsystem with the consumer and the leakage of the at least one hydraulic pump from step (a).

In a next step (d) the determining of the efficiency of the hydraulic system takes place and namely as follows:

In a step (d1) the efficiency of the hydraulic pump in the subsystems is determined in the present operating state, i.e. with the pressure at the hydraulic pump prevailing in the present operation. The operating state can be understood to mean the combination of a movement of the consumer with an effective volume flow and the pressure at the hydraulic pump prevailing in the present state. The pressure at the hydraulic pump currently prevailing is produced as a result of the force which the consumer must apply for generating the movement. “Present” means the point in time at which step (d1) is carried out or the short timespan in which step (d1) is carried out. For this, the volume flow actually conveyed by the pump, calculated from the leakage from step (a) of this hydraulic pump, is set in relation to the volume flow requested by the consumer in the subsystem.

In a step (d2) the efficiency of the consumer or consumers in the present operating state is determined, by the volume flow actually effective for the force conversion (=generation of the movement of the consumers and of the connected actuators) at a particular consumer in the operating state being set in relation to the volume flow actually conveyed by the pump in the operating state and delivered to this consumer. The effective volume flow at the consumer in the operating state results from the leakages from steps (a) and (c) or respectively including these leakages. The volume flow actually delivered by the pump in the operating state to this consumer results from taking into consideration the leakage of the pump from step (a).

According to a first embodiment, provision can be made that step (a) is carried out repeatedly at predeterminable times TA, preferably 1× per day, particularly preferably 1× per hour. With the repetition of step (a), mentioned here, it is ensured that a present profile of the leakage of the hydraulic pump is always available during the subsequent calculations.

In further development of the invention, step (b) can be repeated at predeterminable times T_{B}, wherein in the case of a hydraulic system of a cyclically operating machine, in particular an injection moulding machine, a press or a machine tool, step (b) is carried on in each nth cycle, wherein n is preferably less than 10 and particularly preferably n=1.

In a hydraulic system of a continuously operating machine, in particular an extruder, step (b) can be repeated in predeterminable time steps ΔT, wherein ΔT is preferably less than 10 minutes, in particular less than 1 minute.

According to a further embodiment of the invention, a first subsystem with a hydraulic cylinder and a second subsystem with a hydraulic motor can be provided, wherein the two subsystems can be operated sequentially.

In a further development of the invention, standstill phases can be provided, in which the hydraulic system is not operated and the consumers of the hydraulic system are not actuated, wherein step (a) is carried out in one or several such standstill phases.

In practice, several valves having different functions are present in a hydraulic system. This can be pure shut-off valves or pure switching valves. Other valves, such as for example proportional valves, can likewise also be present. In one or more of the subsystems therefore one or more valves can also be present. According to an embodiment of the invention, provision can be made that the proportion of these valves remains disregarded or respectively is ignored in the determining of the leakage of the consumer of a subsystem.

According to an advantageous embodiment of the invention, in a step (d3) a determining of the efficiency of one or more, preferably of all, of the tested subsystems in the hydraulic system can be carried out, by the actually effective volume flow of a subsystem being set in relation to the requested volume in this subsystem.

Advantageously, a calculation can also be carried out of the average efficiency of the total hydraulic system. For this, the efficiencies of the subsystems are weighted with the proportional durations of the individual process

$${η}_{Total} = \frac{{η}_{1} \cdot {t}_{1} + {η}_{2} \cdot {t}_{2} + ⋯ + {η}_{n} \cdot {t}_{n}}{{t}_{Total}}$$

phases, namely according to wherein ηᵢ is the efficiency of a subsystem and ti is the duration in which the subsystem is operated. The above applies in particular with respect to a hydraulic system of a cyclically operating machine, such as in particular an injection moulding machine, a press or a machine tool. The sum of the individual process phases corresponds here to a cycle of the machine, in particular an injection moulding cycle.

In an injection moulding machine, subsystems can be observed and monitored which are shut off from one another cyclically, because this corresponds to the operation of the injection moulding machine. A permanent monitoring of the hydraulic system thus results during the operation of the injection moulding machine, wherein in each injection moulding cycle measurement values (here leakage values and efficiency values) can be determined. Furthermore, as mentioned above, an average efficiency of the whole hydraulic system can also be determined.

The consumer or consumers can carry out a translatory or a rotatory movement, or respectively a consumer can be configured such that a translatory or a rotatory movement can be carried out.

According to the invention, calculation is carried out only with existing data of the consumers and with measured actual values of the consumers in the operating state. The existing data can be taken from corresponding data sheets of the consumers. This can concern inter alia the following data: displacement of the hydraulic motor, area ratio of the hydraulic cylinder, displacement of the pump. The actual values are measured with suitable sensors. This can concern here inter alia the following variables: rotational speed of the pump, pivot angle of the pump, rotational speed of the hydraulic motor, axial speed of the hydraulic cylinder.

For an understanding of the invention and with regard to the description of example embodiments, the following definitions may be helpful.

“Leakage of a pump”=the volume per unit of time, which is drawn by the pump out from the tank, but is not passed on by the pump to a subsequent consumer. This concerns the difference between the drawn and the delivered volume flow.

“Leakage of a consumer”=the amount of hydraulic oil which is delivered by the pump per unit of time to the consumer, but is not converted into motion at the consumer. This concerns the difference between incoming volume flow and volume flow converted into motion.

“Volume flow”=volume conveyed per unit of time, for example in litres per minute.

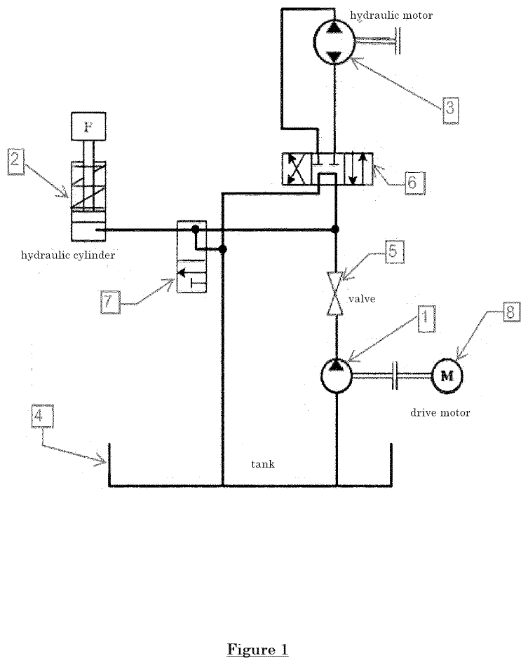

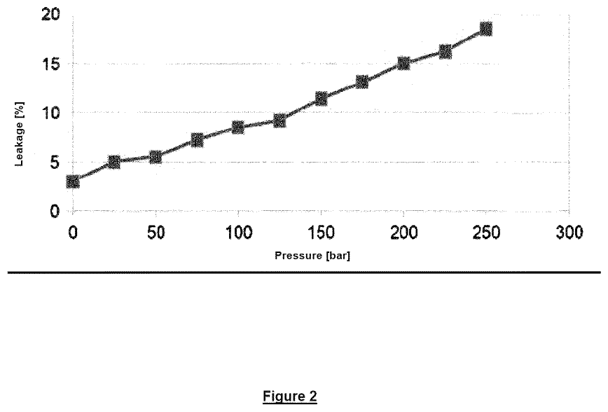

The invention is to be described more closely below with the aid of an example embodiment and with reference to FIGS. 1 and 2.

There are shown:

FIG. 1 block diagram of a hydraulic system

FIG. 2 leakage in the respective operating point of the hydraulic pump.

FIG. 1 shows a block diagram of a hydraulic system with a hydraulic pump 1—sometimes also only abbreviated below as “pump”—and two hydraulic consumers, namely a hydraulic cylinder 2 and a hydraulic motor 3. The supplying of the hydraulic system with a hydraulic fluid, in particular hydraulic oil, takes place from a tank 4. The hydraulic system further comprises a shut-off valve 5, a proportional valve 6 and a switching valve 7. A motor 8 serves for the drive of the hydraulic pump 1. A first subsystem is formed by hydraulic pump 1, shut-off valve 5, switching valve 7 and hydraulic cylinder 2. A second subsystem is formed by hydraulic pump 1, shut-off valve 5, proportional valve 6 and hydraulic motor 3. Disregarding leakages at the valves 5, 6 and 7, the following subsystems can also be considered, namely a first subsystem of hydraulic pump 1 and hydraulic cylinder 2 and a second subsystem of hydraulic pump 2 and hydraulic motor 3.

### Step (a) Determining the Leakage of the Hydraulic Pump

In a first step (a) the leakage of the hydraulic pump in the present state is measured via the pressure. For this, the hydraulic pump 1 is uncoupled from the subsequent hydraulic components by means of the shut-off valve 5.

The starting point for determining the leakage is the control concept of pumps. According to this control concept, it can be specified to the pump how much oil it is to convey, i.e. a target volume flow can be specified. Because the shut-off valve 5 is closed, the specified oil conveying quantity or respectively the target volume flow can flow out from the hydraulic pump 1 only as leakage oil. A particular pressure is established here in the hydraulic pump 1. The more target volume is requested when the valve 5 is shut off, the higher the pressure will be which ensues. The leakage oil flows via a leakage oil line back into the tank 4 and is therefore not available on the output side of the pump 1. The conveyed volume flow of oil thus corresponds to the volume flow of leakage oil. It can therefore be determined at which pressure p which volume flow of leakage oil is present. The target volume flow is increased continuously, preferably in ramped form. Here also predefined levels can be approached. At the same time, the resulting pressure valves and the oil temperature values are detected and recorded continuously. The procedure is preferably carried out over the entire pressure range which is able to be generated by the pump. When the target volume flow is increased in several small steps and thus also the ensuing pressure, an almost continuous course of the volume flow of leakage oil is present over the pressure range of the pump. The procedure is preferably carried out until the pressure threshold value pₘₐₓ of the hydraulic pump or the upper threshold of the operating range of the hydraulic pump is reached.

FIG. 2 shows the result of such an above-mentioned measurement of a hydraulic pump and namely the percentage leakage in the respective pressure-dependent operating point of the hydraulic pump. The leakage of the pump is thus known as supplier for all downstream components and is given as a reference. Through wear mechanisms during its useful life, the leakage of the pump increases over the course of time. The measurement described above is carried out in preferably defined intervals for each hydraulic pump in the system, in order to be able document a trend over time in a suitable database system, and to derive a prediction over the course of wear over future use. As only target values and measured values are used, which already exist today in established hydraulic systems, no additional sensor system is necessary. As a result, the following correlation results:

$${Q}_{{actual}_{Pump}} = {Q}_{target} - {Q}_{{leak}_{Pump}} \qquad ( 1 )$$

As the leakage increases in the course of time, step (a) of the method according to the invention only applies for the point in time which is examined. Therefore, step (a) is repeated from time to time, in particular at regular time intervals. For example, step (a) can be carried out once per day, in particular can always be repeated at the same time point.

In production by means of an injection moulding machine, the leakage of the subsystems and, following therefrom, the leakage of the consumers, can be determined continuously (from cycle to cycle). This is therefore possible because the subsystems are operated sequentially and thus a shutting-off takes place “automatically”. V_{actual} at the cylinder as consumer and N_{actual} at the hydraulic motor as consumer are measured.

For the calculation of the leakage in steps (b), (c) and (d), the most recent leakage curve (corresponding to FIG. 2) of the hydraulic pump is always used.

### Step (b) Determining the Leakage of the Subsystems

In this step, the present leakage of the subsystems, which can be shut off from one another, is determined. As described above, a first subsystem of hydraulic pump 1 and hydraulic cylinder 2, and a second subsystem of hydraulic pump 1 and hydraulic motor 3 can be considered. For determining the leakage, the subsystems are shut off from one another, and each subsystem is operated its own right and the leakage in the operating state is determined.

### (b1) Leakage of the Subsystem of a Pump and a Hydraulic Motor

In the present example embodiment, the leakage on the rotation of the hydraulic motor 3 is determined. Leakages in valves are disregarded here. During the operation of a hydraulic motor 3, a volume flow coming from the hydraulic pump 1 is converted into a rotatory movement. When the valve 6 upstream of the hydraulic motor 3 is switched, oil flows through the hydraulic motor 3 and drives the latter.

The volume flow Q through the hydraulic motor 3 can be converted here directly into a rotational speed N. This takes place through the interpolation of a characteristic curve or through a linear conversion from the data sheet of the pump. In the linear conversion, a displacement V and a maximum rotational speed Nₘₐₓ is given on the data sheet of the pump. The required volume flow of a new hydraulic motor Q_{target} can be calculated for a rotational speed N thereby in

$$\frac{l}{min}$$

therefore through linear interpolation:

$${Q}_{target} = \frac{{N}_{target} \cdot {Q}_{max}}{{N}_{max}} = \frac{{N}_{target} \cdot {V}_{disp}}{1000} \qquad ( 2 )$$

If a characteristic curve with several support points is present, an interpolation is carried out in an analogous manner between the support points of the characteristic curve. If a load is applied on the shaft of the hydraulic motor, a torque results therefrom, which counteracts the rotation of the hydraulic motor. As a result, an oil pressure p_{actual} occurs on the input side of the hydraulic motor. This, like the rotational speed of the motor, is detected by means of a suitable measurement system. In controlled operation, usually for achieving a specific operating state a rotational speed N_{target} is specified, which in the case of a new hydraulic motor can be converted directly by means of formula (2) into the volume flow Q_{target} of this hydraulic motor, and which is requested by the hydraulic pump 1.

If wear occurs in the “pump-hydraulic motor” subsystem under consideration here, which leads to an internal leakage in the pump 1 and/or in the hydraulic motor 3, the desired rotational speed N_{target} can not be reached. Owing to its leakage Qₗₑₐₖ Pump, the pump 1 can not deliver the requested volume flow Q_{target} and/or the hydraulic motor 3, owing to its leakage Qₗₑₐₖ Motor under the applied load can no longer convert the incoming volume flow into a sufficient rotatory movement. The two leakages Qₗₑₐₖ Pump and Qₗₑₐₖ Motor form together the total leakage Qₗₑₐₖ Total of the subsystem of pump 1 and hydraulic motor 3.

Owing to the leakages of pump and hydraulic motor, instead of the specified rotational speed N_{target} a rotational speed N_{actual} occurs, which results from the actually effective volume flow Q_{Motor}. The volume flow Q_{Motor} actually effective at the hydraulic motor 3 is calculated from the target volume flow of the hydraulic motor 3 according to the above equation (2) minus the leakages at the pump 1 and the hydraulic motor 3 as follows:

$${Q}_{Motor} = {Q}_{target} - {Q}_{leak Pump} - {Q}_{leak Motor} \qquad ( 3 )$$

The leakage of the subsystem of pump and hydraulic motor results proceeding from the equation (3) to:

$${Q}_{leak Total} = {Q}_{leak pump} + {Q}_{leak Motor} = {Q}_{target} - {Q}_{Motor} \qquad ( 4 )$$

The conversion of the volume flow Q_{Motor} into an effective revolution with the rotational speed N_{actual} can be described for the hydraulic motor 3 in an analogous manner to the above equation (2) as:

$${N}_{actual} = {Q}_{Motor} \cdot \frac{{N}_{max}}{{Q}_{max}} \qquad ( 5 )$$

From these correlations, ultimately the total leakage of the “pump-hydraulic motor” subsystem can be determined, proceeding from equation (4) and using equation (5) as follows:

$${Q}_{{leak}_{Total}} = {Q}_{target} - \frac{{N}_{actual} \cdot {Q}_{max}}{{N}_{max}} \qquad ( 6 )$$

A practical calculation example is to be presented below concerning the above statements. It is taken from the data sheet that the hydraulic motor 3 has a constant geometric displacement volume and thus a displacement

$${V}_{disp} = 90 \frac{cm \text{?}}{U} .$$

$$\text{?} \text{indicates text missing or illegible when filed}$$

Furthermore, the maximum rotational speed

$${N}_{max} = 300 \frac{U}{min}$$

is indicated. Therefrom, the maximum volume flow Qₘₐₓ in

$$\frac{l}{min}$$

can be calculated in an analogous manner to formula (2):

$${Q}_{max} = \frac{\\ {N}_{max} \cdot {V}_{disp}}{1000} = \frac{300 \frac{U}{min} \cdot 90 \frac{{cm}^{3}}{U}}{1000} = 27 \frac{l}{min} \qquad ( 7 )$$

With a desired target rotational speed of

$${N}_{target} = 100 \frac{U}{min}$$

for the desired operating state, the requested target volume flow by the pump 1 in the new state of the hydraulic motor 3 according to equation (2) is calculated as follows:

$${Q}_{target} = \frac{\\ {N}_{target} \cdot {Q}_{max}}{{N}_{max}} = \frac{100 \frac{U}{min} \cdot 27 \frac{l}{min}}{300 \frac{U}{min}} = 9 \frac{l}{min} \qquad ( 8 )$$

In the operating state, a deviation from the target rotational speed to the actual rotational speed is measured. With the requested volume flow, the hydraulic motor 3 only reaches an actual rotational speed

$${N}_{actual} = 80 \frac{U}{min} \text{?} .$$

$$\text{?} \text{indicates text missing or illegible when filed}$$

A total leakage is present in the “pump-hydraulic motor” subsystem and a lower effective volume flow Q(effective) results therefrom at the hydraulic motor 3:

$${Q}_{Motor} = \frac{\\ {N}_{actual} \cdot {Q}_{max}}{{N}_{max}} = \frac{80 \frac{U}{min} \cdot 27 \frac{l}{min}}{300 \frac{U}{min}} = 7.2 \frac{l}{min} \qquad ( 9 )$$

According to formula (4), the following results:

$${Q}_{{leak}_{Total}} = {Q}_{target} - {Q}_{Motor} = 1.8 \frac{l}{min} \qquad ( 10 )$$

At the end of step (b1) the leakage of the subsystem of pump 1 and hydraulic motor 3 is thus known for the operating state of a particular desired target rotational speed N_{target}.

### (b2) Leakage of the Subsystem of a Pump and a Hydraulic Cylinder

The calculation takes place largely in an analogous manner to the calculations at the hydraulic motor. Only the type of movement which is detected differs. Instead of the rotational speed N_{actual}, the speed V_{actual} of the piston in the hydraulic cylinder 2 is detected. Here, also, a conversion factor exists for determining the volume flows Q, which in this case is described by the diameter of the cylinder and thus of the effective area of the piston for the oil (e.g. 4000 mm²):

$$v = \frac{Q}{{A}_{Cylinder}} \qquad ( 11 )$$

Under load, with this movement, a pressure p occurs. In the presence of a leakage, in this case with a controlled movement, the desired speed V_{target} is not reached, as the calculation of the required target volume flow Q_{target} takes place in an analogous manner to the hydraulic motor with static conversion factors, which do not compensate for a leakage. For a requested speed V_{target} of

$${100}^{\frac{mm}{s}}$$

by way of example, Q_{target} results at

$${Q}_{target} = {v}_{target} \cdot {A}_{Cylinder} = 100 \frac{mm}{s} \cdot 4000 {mm}^{2} = 400000 {mm}^{2} \frac{{mm}^{3}}{s} \qquad ( 12 )$$

With 11=106 mm³ and 1 min=60 s, the following results:

$${Q}_{target} = 24 \frac{l}{min} \qquad ( 13 )$$

If, for example, only a speed V_{actual} of

$${90}^{\frac{mm}{s}}$$

is reached, the difference can be referred back in turn to a leakage. v_{actual} therefore results as a consequence of the effective volume flow Q_{cylinder}. In an analogous manner to the above formula (3) the following results:

$${Q}_{Cylinder} = {Q}_{target} - {Q}_{{leak}_{Cylinder}} - {Q}_{pump} \qquad ( 14 )$$

In an analogous manner to the above equation (4), the total leakage of the “pump-hydraulic cylinder” subsystem applies:

$${Q}_{{leak}_{Total}} = {Q}_{{leak}_{Pump}} + {Q}_{{leak}_{Cylinder}} = {Q}_{target} - {Q}_{Cylinder} \qquad ( 15 )$$

Likewise, in an analogous manner to formula (5), the following applies:

$${v}_{actual} = \frac{{Q}_{Cylinder}}{{A}_{Cylinder}} \qquad ( 16 )$$

The total leakage of the subsystem to the target volume flow Q_{target} and to the effective volume flow Q_{cylinder} from equation (16) as follows:

$$\begin{matrix}{Q}_{{leak}_{Total}} = {Q}_{target} - {v}_{actual} \cdot {A}_{Cylinder} \\ = 400000 \frac{{mm}^{3}}{s} - 90 \frac{mm}{s} \cdot 4000 {mm}^{2} = 40000 \frac{{mm}^{3}}{s}\end{matrix} \qquad ( 17 )$$

Converted, this results in a leakage of

$${2.4}^{\frac{l}{min ’}} .$$

At the end of step (b2) the leakage of the subsystem of pump 1 and hydraulic cylinder 3 is therefore known.

For all the subsystems under consideration, it is to be noted here that the leakage measurement and leakage calculation is valid only for the respectively desired operating state (N_{target} or respectively V_{target}) and the operating pressure ensuing here. For another operating state and consequently for another operating pressure, the leakage of the subsystems must be determined anew, since the leakage itself is dependent on the prevailing operating pressure. As in step (a), however, a characteristic curve has been recorded for the pump for several operating pressures, this is readily possible at any point in time. Calculation is carried out only with existing data of the consumers and with measured actual values of the consumers in the operating state.

### Step (c) Determining the Leakage of the Individual Consumers

In this step, the concern is with the determining of the leakage of the consumers of the subsystems operated according to step (b). This takes place by formation of the difference value between the leakage of the subsystems of step (b) and the leakage of the at least one hydraulic pump of step (a). In step (b) the leakages of the two subsystems “pump-hydraulic motor” and “pump-hydraulic cylinder” were determined at a desired operating state with a prevailing pressure p here. The leakage of the pump at this pressure p is known from step (a). In step (a) this leakage was detected for several pressure values or respectively support points. If p does not correspond exactly to one of the pressure values or support points, the associated leakage can be determined through interpolation of the support points. The leakage of the consumer of the subsystem under consideration for the system pressure p can consequently be calculated:

$${Q}_{Consumer} = {Q}_{total} - {Q}_{leak pump} \qquad ( 18 )$$

The described method for determining the leakage of individual consumers can be applied for each axis downstream of the pump and thus for each of the consumers downstream of the pump, in so far as a rotational speed (consumer=hydraulic motor) or position/speed (consumer=hydraulic cylinder) can be measured and the associated displacement (hydraulic motor) or the effective area of the force transmission (hydraulic cylinder) are known. In addition, the applied oil pressure p must be able to be detected.

### (c1) Leakage of the Hydraulic Motor

In the example of (b1), the hydraulic motor requests from the hydraulic pump 1 a volume flow

$${Q}_{target} = 9 \frac{l}{min} ,$$

wherein an operating pressure of 200 bar ensues at the hydraulic pump 1, in order to deliver this volume flow. At this pressure in step (a) a leakage of the hydraulic pump 1 of 15% was measured (see FIG. 2). The hydraulic motor therefore does not receive the requested volume flow Q_{target} of

$${9}^{\frac{l}{min}}$$

but rather only an effective volume flow Q_{Motor} of

$${7.65}^{\frac{l}{min}}$$

corresponding to a leakage of 15% of

$${9}^{\frac{l}{min}} .$$

The leakage of the hydraulic motor 3, which represents the consumer in the subsystem of pump and hydraulic motor, therefore results taking into consideration the total leakage of this subsystem from the equation (10) as follows:

$$\begin{matrix}{Q}_{{leak}_{Motor}} = {Q}_{{leak}_{Total}} - {Q}_{{leak}_{Pump}} = 1.8 \frac{l}{min} - 1.35 \frac{l}{min} \\ = 0.45 \frac{l}{min}\end{matrix} \qquad ( 19 )$$

### (c2) Leakage of the Hydraulic Cylinder

In the example from (b2) the hydraulic cylinder requests from the hydraulic pump 1 a target volume flow of

$${Q}_{target} = {24}^{\frac{l}{min}}$$

wherein an operating pressure of 50 bar ensues at the hydraulic pump 1, in order to deliver this volume flow. At this pressure, in step (a) a leakage of the hydraulic pump of 5.5% was measured (see FIG. 2). Consequently, a leakage results for the pump in the amount of 5.5% of Q_{target}, i.e. in the amount of

$${1.32}^{\frac{l}{min}} .$$

The leakage of the hydraulic cylinder 2, which represents the consumer in the subsystem of pump and hydraulic cylinder, results taking into consideration the total leakage for this subsystem from the equation (17) therefore as follows:

$$\begin{matrix}{Q}_{{leak}_{Cylinder}} = {Q}_{{leak}_{Total}} - {Q}_{{leak}_{Pump}} = 2.4 \frac{l}{min} - 1.32 \frac{l}{min} \\ = 1.08 \frac{l}{min}\end{matrix} \qquad ( 20 )$$

### Step (d) Determining the Efficiency of the Hydraulic System

The efficiency results from the comparison of the new state and with the actual state of the respective hydraulic component. This comparison therefore concerns here the pump 1, the hydraulic cylinder 2 and the hydraulic motor 3. Firstly here the volume flow is determined which the consumer (hydraulic motor 3, hydraulic cylinder 1) would have in the new state. For this, maximum values or characteristic curves can be contained in the data sheets via which the required volume flow of oil can be calculated at an associated speed of a consumer. In the case of a hydraulic motor, the speed corresponds to the rotational speed. For example, according to the data sheet in the new state of the hydraulic motor with a revolution of

$${300}^{\frac{l}{min}}$$

a volume flow of

$${40}^{\frac{l}{min}}$$

could be achieved. However, it is also conceivable that these data are determined during the startup of a machine. It is calibrated/adjusted there in the new state. The data sheets would then not always be necessary. In addition, deviations from the data sheets can also already exist in the new state. In the case of a hydraulic cylinder, the concern is the actual speed at which the piston is moved. For example, with an area of 4000 mm² according to the data sheet in the new state of the hydraulic cylinder 2 according to formula (19) a speed of

$${100}^{\frac{min}{s}}$$

could be achieved at a volume flow of

$${24}^{\frac{l}{min}} .$$

In the new state, the actual volume flow Q_{actual} corresponds to the target volume flow Q_{target}. In the actual state the leakages come into play in the hydraulic system. These leakages are determined as described above. Ultimately, the actual volume flow Q_{actual} at a component corresponds to the target volume flow Q_{target} of this component minus the leakage volume flow Qₗₑₐₖ. Subsequently, the efficiencies of the hydraulic components are determined specifically.

### (d1) Efficiency of the Pump in the Subsystems

For this, for the individual subsystems, the actually conveyed volume flow Q_{actualPump} calculated from the leakage is set in relation to the requested volume flow Q_{target}. Q_{target} corresponds in the new state to the actually conveyed volume flow.

(d1.1) Efficiency of the Pump in the Subsystem with Hydraulic Motor

In the example from (b1) the hydraulic motor requests from the hydraulic pump

$${Q}_{target} = {9}^{\frac{l}{min}}$$

wherein an operating pressure of 200 bar ensues at the hydraulic pump, in order to deliver this quantity. At this pressure, in step (a) a leakage of the hydraulic pump of 15% was measured (see FIG. 2). The pump therefore does not deliver the requested quantity of

$${9}^{\frac{l}{min}}$$

but rather only

$${7.65}^{\frac{l}{min}} .$$

The efficiency can therefore be calculated for a pressure of 200 bar:

$${η}_{Pump , 200 bar} = \frac{{Q}_{actual , Pump}}{{Q}_{target}} = \frac{7.65 \frac{l}{min}}{9 \frac{l}{min}} = 0.85 = 85 \% \qquad ( 21 )$$

(d1.2) Efficiency of the Pump in the Subsystem with Hydraulic Cylinder

In the example from (b2) the cylinder requests a target volume flow of

$${Q}_{target} = {24}^{\cdot \frac{l}{min}}$$

and a pressure of 50 bar ensues. At this operating pressure, the hydraulic pump has a leakage of 5.5%, corresponding to 1.32 l/min. Thus, an effective volume flow of Q_{actualPump} of

$${22.68}^{\cdot \frac{l}{min}}$$

results. The efficiency of the pump for this subsystem can thus be calculated at:

$${η}_{Pump , 50 bar} = \frac{{Q}_{actual , Pump}}{{Q}_{target}} = \frac{22.68 \frac{l}{min}}{24 \frac{l}{min}} = 0.95 = 95 \% \qquad ( 22 )$$

### (d2) Determining the Efficiency of the Consumers in Operating State

For this, the volume flow Q_{consumer} actually effective for the force conversion at the consumer is set in relation to the volume flow Q_{actualPump} actually delivered by the pump to this consumer and namely for the values corresponding to the examined operating state.

### Hydraulic Motor

The hydraulic motor in the subsystem of pump and hydraulic motor, as calculated in (c1), does not receive the quantity of

$${9}^{\frac{l}{min}}$$

requested by the pump, but rather only

$${7.65}^{\frac{l}{min}}$$

as the pump already has a leakage. In addition, from this knowledge it was already calculated in (c1) that the leakage of the hydraulic motor is consequently

$${0.45}^{\frac{l}{min}}$$

(see equation 18)). Proceeding from the calculated leakages of pump 1 and hydraulic motor 3, it is now possible to determine an efficiency of the hydraulic motor as follows.

$$\begin{matrix}{η}_{hydmot} = 1 - \frac{{Q}_{{leak}_{Motor}}}{{Q}_{target} - {Q}_{{leak}_{Pump}}} \\ = 1 - \frac{0.45 \frac{l}{min}}{9 \frac{l}{min} - 1.35 \frac{l}{min}} \\ = 1 - 0.59\end{matrix} \qquad ( 23 )$$

Alternatively the efficiency can be calculated from the volume flows. For the determining of the volume flow Q_{Motor} effective at the hydraulic motor, the above equations (5) and (9) apply, i.e. in the example Q_{Motor}=7.2 l/min. For the determining of the actual volume flow of the pump, equation (1) applies, i.e. in the example from d(1.1)

$${Q}_{actualPump} = {7.65}^{\frac{l}{min}} .$$

Proceeding herefrom, the efficiency of the hydraulic motor is calculated as follows:

$${η}_{hydmot} = \frac{{Q}_{Motor}}{{Q}_{{actual}_{Pump}}} = 0.941 = 94.1 \% \qquad ( 24 )$$

### Hydraulic Cylinder

In an analogous manner, the efficiency for the hydraulic cylinder 2 can be determined in its operating state:

$$\begin{matrix}{η}_{Cylinder} = 1 - \frac{{Q}_{{leak}_{Cylinder}}}{{Q}_{target} - {Q}_{{leak}_{Pump}}} \\ = 1 - \frac{1.08 \frac{l}{min}}{24 \frac{l}{min} - 1.32 \frac{1}{min}} \\ = 1 - 0.048 \\ = 95.4 \%\end{matrix} \qquad ( 25 )$$

Alternatively, the efficiency can be calculated from the volume flows. For the determining of the volume flow Q_{cylinder} effective at the hydraulic cylinder, the above equation (16) applies, and consequently in the example a value of

$${Q}_{Cyliner} = {21.6}^{\frac{l}{min}} .$$

For the determining of the effective volume flow of the pump, the equation (1) applies, i.e. in the example from d(2.2)

$${Q}_{actualPump} = 22 {\text{.68}}^{\frac{l}{min}} .$$

Proceeding herefrom, the efficiency of the hydraulic cylinder is calculated as follows:

$${η}_{Cylinder} = \frac{{Q}_{Cylinder}}{{Q}_{{actual}_{Pump}}} 0.954 = 95.4 \% \qquad ( 26 )$$

### (d3) Determining the Efficiency of the Respective Subsystem

For this, the actually effective volume flow at a consumer of a subsystem in this subsystem is set in relation to the volume flow requested by this consumer. The requested volume flow Q_{target} corresponds to the actual volume flow in the new state.

For the subsystem with hydraulic motor:

$${η}_{{Total}_{Subsystem Motor}} = \frac{{Q}_{Motor}}{{Q}_{target}} = \frac{7.2 \frac{l}{min}}{9 \frac{l}{min}} = 0.8 = 80 \% \qquad ( 27 )$$

For the subsystem hydraulic cylinder:

$${η}_{{Total}_{Subsystem Cylinder}} = \frac{{Q}_{Cylinder}}{{Q}_{target}} = \frac{21.6 \frac{l}{min}}{24 \frac{l}{min}} = 0.9 = 90 \% \qquad ( 28 )$$

### (e) Average Efficiency of the Total System

In a further development of the invention, provision can be made that in the case of a cyclically operating machine, in particular an injection moulding machine, the average efficiency of the total hydraulic system is determined. Here, it is taken into account how long a subsystem is operated in the injection moulding cycle. The average efficiency of the total system can be calculated therefrom for the set process. If in the example system the hydraulic motor is operated for 9 seconds per cycle and the cylinder is operated for 1 second, the average efficiency of the total system results as follows:

$${η}_{Total} = \frac{{η}_{1} \cdot {t}_{1} + {η}_{2} \cdot {t}_{2} + … + {η}_{n} \cdot {t}_{n}}{{t}_{Total}} = \frac{9 s \cdot 80 \% + 1 s \cdot 90 \%}{10 s} = 81 \% \qquad ( 29 )$$

### LIST OF REFERENCE NUMBERS

1 hydraulic pump
2 hydraulic cylinder
3 hydraulic motor
4 tank
5 shut-off valve
6 proportional valve
7 switching valve
8 drive motor

1. A method for monitoring a hydraulic system comprising several hydraulic components, comprising a source of a hydraulic fluid, at least one hydraulic pump and one or more hydraulic consumers, which are flowed through by the hydraulic fluid which is conveyed by the hydraulic pump, wherein the method comprises the following steps:
(a) Determining the leakage of the at least one hydraulic pump as a function of the pressure via predeterminable values of the pressure;
(b) Operation of one or more hydraulic subsystems of the hydraulic system which can be shut off from one another, and determining of the present leakage of these subsystems in the operating state, wherein a subsystem of the at least one hydraulic pump of step (a) and a consumer is formed;
(c) Determining the leakage of the consumers of the subsystems operated according to step (b) by formation of the difference value between the leakage of the at least one hydraulic pump of step (a) and the leakage of the subsystem of step (b) which has the above-mentioned consumer,
(d) Determining the efficiency of the components of the hydraulic system according to the steps:
(d1) Determining the efficiency of the pump in the subsystems in the operating state, by the volume flow Q_{actualPump}, actually conveyed by the pump, calculated from the leakage of step (a), being set in relation to the volume flow Q_{target} requested in the subsystem by the consumer,
(d2) Determining the efficiency of the consumer or consumers in the operating state, by the volume flow Q_{consumer} actually effective for the force conversion at a particular consumer in the operating state being set in relation to the volume flow Q_{actual} actually conveyed by the pump and delivered to this consumer, wherein the volume flow effective at the consumer in the operating state results from the leakages from steps (a) and (c) and the volume flow actually delivered by the pump in the operating state to this consumer results taking into consideration the leakage of the pump from step (a).

2. The method according to claim 1, wherein
the step (a) (learning phase or respectively automated reference formation) is carried out repeatedly at predeterminable times T_{A}.

3. The method according to claim 1, wherein
the step (b) is repeated at predeterminable times T_{B}, wherein in the case of a hydraulic system of a cyclically operating machine, the step (b) is carried out in every nth cycle, wherein n is less than 10.

4. The method according to claim 1,
wherein in the case of a hydraulic system or a continuously operating machine, the step (b) is repeated in predeterminable time steps ΔT, wherein ΔT is less than 10 minutes.

5. The method according to claim 1,
wherein
a first subsystem is provided with a hydraulic cylinder and a second subsystem is provided with a hydraulic motor, and that the two subsystems are operated sequentially.

6. The method according to claim 1,
wherein
standstill phases are provided in which the hydraulic system is not operated and the consumers of the hydraulic system are not actuated, and that the step (a) is carried out in one or more standstill phases.

7. The method according to claim 1,
wherein
in one or more subsystems one or more valves are present, and that the proportion of these valves remains unconsidered or respectively is disregarded in the determining of the leakage of the consumer of a subsystem.

8. The method according to claim 1,
wherein
the determining of the efficiency of one or more of the examined subsystems is carried out in the hydraulic system, by the actually effective volume flow of a subsystem Q_{consumer} being set in relation to the requested volume flow Q_{target} in this subsystem.

9. The method according to claim 1,
wherein
a calculation of the average efficiency of the total hydraulic system is carried out, but the efficiencies of the subsystems being weighted with the proportional durations of the individual process phases, namely according to
$${η}_{Total} = \frac{{η}_{1} \cdot {t}_{1} + {η}_{2} \cdot {t}_{2} + … + {η}_{n} \cdot {t}_{n}}{{t}_{Total}} ,$$
wherein η is the efficiency of a subsystem and t is the duration in which the subsystem is operated.

10. The method according to claim 9, wherein
a hydraulic system of a cyclically operating machine is concerned, and that the sum of the individual process phases corresponds to a cycle.

11. The method according to claim 1,
wherein
the consumer or consumers carry out a translatory or a rotatory movement or respectively are configured such that a translatory or a rotatory movement can be carried out.
